(19) United States
(12) Patent Application Publication
(10) Pub. No.: US 2006/0155069 A1
(43) Pub. Date: Jul. 13, 2006

(54) Process for making lightly cross-linked thermoplastic polyolefin elastomers

(75) Inventors: Dominic A. Berta, Newark, DE (US); Cheng Q. Song, Green Brook, NJ (US); Lorie Ann Struzik, Landenberg, PA (US); Giampaolo Pellegatti, Baura (FE) (IT)

Correspondence Address: BASELL USA INC., INTELLECTUAL PROPERTY, 912 APPLETON ROAD, ELKTON, MD, 21921, US

(73) Assignee: Basell Poliolefine Italia s.r.l., Milan (IT)

(21) Appl. No.: 11/325,788

(22) Filed: Jan. 5, 2006

Related U.S. Application Data
(60) Provisional application No. 60/643,034, filed on Jan. 11, 2005.

(51) Int. Cl. C08F 8/00

(52) U.S. Cl. 525/192

(57) ABSTRACT

A process for making a thermoplastic polyolefin elastomer comprising: a) preparing a polymer mixture comprising: (I) about 70 to about 95% by weight of a heterophasic polyolefin; (II) about 4.9 to about 27% by weight of a reactive, peroxide-containing olefin polymer; (III) about 0.1 to about 3.0% by weight of an organic peroxide; and (IV) optionally, about 1 to about 10% by weight of a co-agent having a molecular structure containing at least two aliphatic unsaturated carbon-carbon bonds; wherein (I)+(II)+(III)+(IV) equals 100%; b) extruding or compounding in molten state the polymer mixture, thereby producing a melt mixture; and optionally c) pelletizing the melt mixture.

### FIELD OF THE INVENTION

This invention relates to a process for preparing lightly crosslinked thermoplastic polyolefin elastomers with improved elastomeric properties.

### BACKGROUND OF THE INVENTION

Olefinic thermoplastic elastomers have been used in various extrusion applications since they can be processed by using commonly known extrusion techniques usually associated with the use of thermoplastic resins. Such products have been particularly useful when a good combination of elastic properties and mechanical properties of the polymer is required. In these applications, they replace conventional elastomers which require specific processes including mixing with additives, moulding and crosslinking. Moreover, the thermoplastic elastomeric products, unlike the conventional elastomers used in thermoforming processes, can be totally or partially recycled.

Among the various thermoplastic elastomeric products, those which comprise a crystalline or semicrystalline polypropylene phase and an amorphous phase constituted generally by an ethylene/alpha-olefin/diene rubber, are often not satisfactory, either due to the compatibility problems between the elastomeric phase and the crystalline phase or the presence of residual crystallinity in the elastomeric phase.

One of the methods proposed for improving the compatibility of the two phases consists in producing the compositions directly in the reactor by means of sequential polymerization in a multi-stage process. In the first stage, the propylene-based crystalline copolymer is generally produced, while the second stage comprises the polymerization of ethylene/propylene mixtures in the presence of the product obtained in the first stage, in order to obtain elastomeric copolymers. Both stages of these processes are carried out in the presence of the same catalytic system which generally consists of a conventional catalyst of the Ziegler/Natta type comprising a titanium compound supported on a magnesium halide in active form. Compositions obtained by means of this type of process are described in U.S. Pat. No. 4,521,566 and U.S. Pat. No. 5,286,564. An analogous process is described in EP-A-433,989 and EP-A-433,990 in which an unsupported metallocene catalyst is used in both polymerization stages. The products obtained in these processes, however, do not have a suitable balance of elasto-mechanical properties.

U.S. Pat. No. 6,100,333 discloses a polyolefin composition comprising a crystalline propylene polymer and an elastomeric ethylene copolymer which are capable of producing, after dynamic vulcanization, thermoplastic elastomeric products having optimum elastomeric properties and a good balance of elasto-mechanical properties. The claimed invention uses crosslinking agents, such as organic peroxides, to improve the physico-mechanical properties of the polyolefin materials.

It is well known that organic peroxides usually produce a crosslinked or partially crosslinked olefin polymer which has high melt viscosity resulting in high energy cost and non-uniform mixing. Furthermore, the addition of large amounts of organic peroxide to the olefin polymers could also produce large amounts of gel, as recognized in U.S. Pat. No. 5,037,890. It discloses that organic peroxide used in a grafting reaction possesses many problems, such as susceptibility to gellation and promoting homopolymerization of the grafting monomer, therefore, lowers grafting efficiency, since most free radicals formed by decomposition of the organic peroxide are not attached to the backbone of the olefin polymer materials.

Accordingly, it is an object of this invention to produce a thermoplastic polyolefin elastomer with low melt viscosity and improved elastomeric properties.

### SUMMARY OF THE INVENTION

In accordance with the present invention, a process for making a thermoplastic polyolefin elastomer comprises:
a) preparing a polymer mixture comprising:
   (I) about 70 to about 95% by weight of a heterophasic polyolefin composition comprising:
      A) about 8 to about 40% by weight of a crystalline polymer fraction selected from:
         (i) a propylene homopolymer, having solubility in xylene at room temperature lower than about 10% by weight;
         (ii) a copolymer of propylene and at least one alpha-olefin of formula H₂C═CHR, where R is H or a C₂₋₁₀ linear or branched alkyl, containing at least 85% by weight of propylene, having solubility in xylene at room temperature lower than about 15% by weight; and
         (iii) a mixture of (i) and (ii); and
      B) about 60 to about 92% by weight of an elastomeric fraction comprising at least an elastomeric copolymer of propylene or ethylene with about 15 to about 45% by weight of at least one alpha-olefin of formula H₂C═CHR, where R is H or a C₂₋₁₀ linear or branched alkyl, optionally containing about 0.5 to about 5% by weight of a diene, and having solubility in xylene at room temperature greater than about 50% by weight, the intrinsic viscosity of the xylene soluble fraction ranging from about 3.0 to about 6.5 dl/g;
   (II) about 5 to about 27.0% by weight of a reactive, peroxide-containing olefin polymer;
   (III) about 0.1 to about 3.0% by weight of an organic peroxide; and
   (IV) optionally, about 1 to about 10% by weight of a co-agent having a molecular structure containing at least two aliphatic unsaturated carbon-carbon bonds; wherein (I)+(II)+(III)+(IV) equals 100%;
b) extruding or compounding in molten state the polymer mixture, thereby producing a melt mixture; and optionally
c) pelletizing the melt mixture.

### DETAILED DESCRIPTION OF THE INVENTION

The polymer mixture of the present invention comprises from about 70 to about 95% by weight, preferably from about 80 to about 92%, and more preferably from about 85 to about 90% of a heterophasic polyolefin composition (I), comprising:
A) from about 8 to about 40% by weight, preferably from about 10 to about 20%, and more preferably from about 12 to about 18% of a crystalline polymer fraction selected from:
   (i) a propylene homopolymer, having solubility in xylene at room temperature lower than about 10% by weight;
   (ii) a copolymer of propylene and at least one alpha-olefin of formula H₂C═CHR, where R is H or a C₂₋₁₀ linear or branched alkyl, containing at least about 85% by weight of propylene, having solubility in xylene at room temperature lower than about 15% by weight; and
   (iii) a mixture of (i) and (ii); and
B) from about 60 to about 92% by weight, preferably from about 80 to about 90%, and more preferably from about 82 to about 88% of an elastomeric fraction comprising at least an elastomeric copolymer of propylene or ethylene with about 15 to about 45% by weight of at least one alpha-olefin of formula H₂C═CHR, where R is H or a C₂₋₁₀ linear or branched alkyl, optionally containing about 0.5 to about 5% by weight of a diene, and having solubility in xylene at room temperature greater than about 50% by weight, the intrinsic viscosity of the xylene soluble fraction ranging from about 3.0 to about 6.5 dl/g.

In the crystalline polymer fraction (A), the homopolymer (i) has solubility in xylene at room temperature preferably lower than about 5% by weight, and more preferably lower than about 3%. The copolymer of propylene (ii) contains preferably at least about 90% by weight propylene, and has solubility in xylene at room temperature preferably lower than about 10% by weight, and more preferably lower than about 8%. Said alpha-olefin is preferably ethylene, butene-1, pentene-1,4-methylpentene, hexene-1, octene-1 or combinations thereof, and more preferably the copolymer of propylene (ii) is a copolymer of propylene and ethylene.

The elastomeric fraction (B) of heterophasic polyolefin composition (I) preferably contains from about 20 to about 40% by weight alpha-olefin, and has solubility in xylene at room temperature greater than about 80% by weight, the intrinsic viscosity of the xylene soluble fraction ranging from about 4.0 to about 5.5 dl/g.

According to a preferred embodiment of the compositions of the present invention, the elastomeric fraction (B) of the polyolefin compositions of the invention comprises a first elastomeric copolymer (1) and a second elastomeric copolymer (2).

More preferably, said elastomeric fraction comprises:
(1) a first elastomeric copolymer of propylene or ethylene with at least one alpha-olefin of formula H₂C═CHR, where R is H or a C₂₋₁₀ linear or branched alkyl, optionally containing about 0.5 to about 5% by weight of a diene, said first elastomeric copolymer containing from about 15 to about 32% by weight alpha-olefin, preferably from about 20 to about 30%, and having solubility in xylene at room temperature greater than about 40% by weight, the intrinsic viscosity of the xylene soluble fraction ranging from about 3.0 to about 5.0 dl/g; and
(2) a second elastomeric copolymer of propylene with at least one alpha-olefin of formula H₂C═CHR, where R is H or a C₂₋₁₀ linear or branched alkyl, optionally containing about 0.5 to about 5% by weight of a diene, said second elastomeric copolymer containing more than about 15% up to about 45% by weight alpha-olefin, preferably from about 35 to about 40%, and having solubility in xylene at room temperature greater than about 80% by weight, the intrinsic viscosity of the xylene soluble fraction ranging from about 4.0 to about 6.5 dl/g;
   the (1)/(2) weight ratio ranging from about 1:5 to about 5:1, preferably from about 1:2 to about 4:1, and more preferably from about 1:1 to about 2:1.

The first elastomeric copolymer (1) is preferably a copolymer of propylene with at least one alpha-olefin selected from ethylene, butene-1, hexene-1 and octene-1; more preferably said alpha-olefin is ethylene. The first elastomeric copolymer (1) has a solubility in xylene at room temperature greater than about 40% by weight, preferably greater than about 70%, and more preferably greater than about 80%; the intrinsic viscosity of the xylene soluble fraction ranges from about 3.0 to about 5.0 dl/g, preferably from about 3.5 to about 4.5 dl/g, and more preferably from about 3.8 to about 4.3 dl/g.

The second elastomeric copolymer (2) is preferably a copolymer of propylene with at least one alpha-olefin selected from ethylene, butene-1, hexene-1 and octene-1; more preferably, said alpha-olefin is ethylene. The second elastomeric copolymer (2) has solubility in xylene at room temperature greater than about 80% by weight, preferably greater than about 85%, and the intrinsic viscosity of the xylene soluble fraction ranges from about 4.0 to about 6.5 dl/g, preferably from about 4.5 to about 6.0, and more preferably from about 5.0 to about 5.7 dl/g.

The copolymerization of propylene and ethylene or another alpha-olefin or combinations thereof, to form the copolymers (1) and (2) of the elastomeric fraction (B) can occur in the presence of a diene, conjugated or not, such as butadiene, 1,4-hexadiene, 1,5-hexadiene and ethylidene-norbornene-1. The diene, when present, is contained in an amount of from about 0.5 to about 5% by weight, with respect to the weight of the fraction (B).

According to a preferred embodiment of the invention, the heterophasic polyolefin composition (1) is in the form of spherical particles having an average diameter of 250 to 7,000 microns, a flowability of less than 30 seconds and a bulk density (compacted) greater than 0.4 g/ml.

The heterophasic polyolefin composition (I) may be prepared by sequential polymerization in at least two sequential polymerization stages, with each subsequent polymerization being conducted in the presence of the polymeric material formed in the immediately preceding polymerization reaction. The polymerization stages may be carried out in the presence of a Ziegler-Natta and/or a metallocene catalyst.

According to a preferred embodiment, all the polymerization stages are carried out in the presence of a catalyst comprising a trialkylaluminum compound, optionally an electron donor, and a solid catalyst component comprising a halide or halogen-alcoholate of Ti and an electron donor compound supported on anhydrous magnesium chloride, said solid catalyst component having a surface area (measured by BET) of less than 200 m²/g, and a porosity (measured by BET) higher than 0.2 ml/g. Catalysts having the above mentioned characteristics are well known in the patent literature; particularly advantageous are the catalysts described in U.S. Pat. No. 4,399,054 and EP-A-45 977. Other examples can be found in U.S. Pat. No. 4,472,524.

The polymerization process is described in detail in the International Application WO 03/011962, the disclosure of which is incorporated herein by reference.

The solid catalyst components used in said catalysts comprise, as electron-donors (internal donors), compounds selected from the group consisting of ethers, ketones, lactones, compounds containing N, P and/or S atoms, and esters of mono- and dicarboxylic acids.

Particularly suitable electron-donor compounds are phthalic acid esters, such as diisobutyl, dioctyl, diphenyl and benzylbutyl phthalate. Other electron-donors particularly suitable are 1,3-diethers of formula: 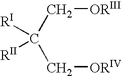
wherein R^{I} and R^{II}, the same or different from each other, are C₁-C₁₈ alkyl, C₃-C₁₈ cycloalkyl or C₇-C₁₈ aryl radicals; R^{III} and R^{IV}, the same or different from each other, are C₁-C₄ alkyl radicals; or are the 1,3-diethers in which the carbon atom in position 2 belongs to a cyclic or polycyclic structure made up of 5, 6 or 7 carbon atoms and containing two or three unsaturations. Ethers of this type are described in EP-A-361 493 and EP-A-728 769. Representative examples of said diethers are 2-methyl-2-isopropyl-1,3-dimethoxypropane, 2,2-diisobutyl-1,3-dimethoxypropane, 2-isopropyl-2-cyclopentyl-1,3-dimethoxypropane, 2-isopropyl-2-isoamyl-1,3-dimethoxypropane, and 9,9-bis(methoxymethyl)fluorene.

The preparation of the above mentioned catalyst components is carried out according to known methods. For example, a MgCl₂.nROH adduct (in particular in the form of spheroidal particles) wherein n generally ranges from 1 to 3 and ROH is ethanol, butanol or isobutanol, is reacted with an excess of TiCl₄ containing the electron-donor compound. The reaction temperature is generally comprised between 80 and 120° C. The solid is then isolated and reacted once more with TiCl₄, in the presence or absence of the electron-donor compound; it is then separated and washed with a hydrocarbon until all chlorine ions have disappeared.

In the solid catalyst component the titanium compound, expressed as Ti, is generally present in an amount from 0.5 to 10% by weight. The quantity of electron-donor compound which remains fixed on the solid catalyst component generally is 5 to 20% by moles with respect to the magnesium dihalide.

The titanium compounds which can be used in the preparation of the solid catalyst component are the halides and the halogen alcoholates of titanium. Titanium tetrachloride is the preferred compound.

The reactions described above result in the formation of a magnesium halide in active form. Other reactions are known in the literature, which cause the formation of magnesium halide in active form starting from magnesium compounds other than halides, such as magnesium carboxylates.

The Al-alkyl compounds used as co-catalysts comprise Al-trialkyls, such as Al-triethyl, Al-triisobutyl, Al-tri-n-butyl, and linear or cyclic Al-alkyl compounds containing two or more Al atoms bonded to each other by way of O or N atoms, or SO₄ or SO₃ groups. The Al-alkyl compound is generally used in such a quantity that the Al/Ti ratio is from 1 to 1000.

Electron-donor compounds that can be used as external donors include aromatic acid esters such as alkyl benzoates, and in particular silicon compounds containing at least one Si—OR bond, where R is a hydrocarbon radical. Examples of silicon compounds are (tert-butyl)₂Si(OCH₃)₂, (cyclohexyl)(methyl) Si(OCH₃)₂, (phenyl)₂Si(OCH₃)₂ and (cyclopentyl)₂Si(OCH₃)₂. 1,3-diethers having the formulae described above can also be used advantageously. If the internal donor is one of these diethers, the external donors can be omitted.

The solid catalyst component have preferably a surface area (measured by BET) of less than 200 m²/g, and more preferably ranging from 80 to 170 m²/g, and a porosity (measured by BET) preferably greater than 0.2 ml/g, and more preferably from 0.25 to 0.5 ml/g.

The catalysts may be precontacted with small quantities of olefin (prepolymerization), maintaining the catalyst in suspension in a hydrocarbon solvent, and polymerizing at temperatures from room temperature to 60° C., thus producing a quantity of polymer from 0.5 to 3 times the weight of the catalyst. The operation can also take place in liquid monomer, producing, in this case, a quantity of polymer 1000 times the weight of the catalyst.

By using the above mentioned catalysts, the polyolefin compositions are obtained in spheroidal particle form, the particles having an average diameter from about 250 to 7,000 microns, a flowability of less than 30 seconds and a bulk density (compacted) greater than 0.4 g/ml.

Other catalysts that may be used to prepare the heterophasic polyolefin composition (I) are metallocene-type catalysts, as described in U.S. Pat. No. 5,324,800 and EP-A-0 129 368; particularly advantageous are bridged bis-indenyl metallocenes, for instance as described in U.S. Pat. No. 5,145,819 and EP-A-0 485 823. Another class of suitable catalysts are the so-called constrained geometry catalysts, as described in EP-A-0 416 815, EP-A-0 420 436, EP-A-0 671 404, EP-A-0 643 066 and WO 91/04257. These metallocene compounds may be advantageously used to produce the elastomeric copolymers (B)(1) and (B)(2).

According to a preferred embodiment, the polymerization process comprises three stages, all carried out in the presence of Ziegler-Natta catalysts, where in the first stage the relevant monomer(s) are polymerized to form the fraction (A); in the second stage a mixture of propylene and an alpha-olefin and optionally a diene are polymerized to form the elastomeric copolymer (B)(1); and in the third stage a mixture of ethylene or propylene and an alpha-olefin and optionally a diene are polymerized to form the elastomeric copolymer (B)(2).

The polymerization stages may occur in liquid phase, in gas phase or liquid-gas phase. Preferably, the polymerization of the crystalline polymer fraction (A) is carried out in liquid monomer (e.g. using liquid propylene as diluent), while the copolymerization stages of the elastomeric copolymers (B)(1) and (B)(2) are carried out in gas phase, without intermediate stages except for the partial de-gassing of the propylene. According to a most preferred embodiment, all the three sequential polymerization stages are carried out in gas phase.

The reaction temperature in the polymerization stage for the preparation of the crystalline polymer fraction (A) and in the preparation of the elastomeric copolymers (B)(1) and (B)(2) can be the same or different, and is preferably from 40° C. to 90° C.; more preferably, the reaction temperature ranges from 50 to 80° C. in the preparation of the fraction (A), and from 40 to 80° C. for the preparation of components (B)(1) and (B)(2).

The pressure of the polymerization stage to prepare the fraction (A), if carried out in liquid monomer, is the one which competes with the vapor pressure of the liquid propylene at the operating temperature used, and it may be modified by the vapor pressure of the small quantity of inert diluent used to feed the catalyst mixture, by the overpressure of optional monomers and by the hydrogen used as molecular weight regulator.

The polymerization pressure preferably ranges from 33 to 43 bar, if done in liquid phase, and from 5 to 30 bar if done in gas phase. The residence times relative to the two stages depend on the desired ratio between the fractions (A) and (B), and can usually range from 15 minutes to 8 hours. Conventional molecular weight regulators known in the art, such as chain transfer agents (e.g. hydrogen or ZnEt₂), may be used.

The polymer mixture comprises from about 4.9 to about 27% by weight, preferably from about 8 to about 20%, and more preferably from about 10 to about 15% of a reactive, peroxide-containing olefin polymer material. Olefin polymer suitable as a starting material for the reactive, peroxide-containing olefin polymer material is a propylene polymer material, an ethylene polymer material, a butene-1 polymer material, or mixtures thereof. The olefin polymer can be selected from:
(a) a crystalline homopolymer of propylene having solubility in xylene at room temperature lower than about 20%, preferably about 10% to about 0.5%;
(b) a crystalline, random copolymer of propylene with an olefin selected from ethylene and C₄-C₁₀ α-olefins wherein the polymerized olefin content is about 1-10% by weight, preferably about 2% to about 8%, when ethylene is used, and about 1% to about 20% by weight, preferably about 2% to about 16%, when the C₄-C₁₀ α-olefin is used, the copolymer having solubility in xylene at room temperature lower than about 40%, preferably at most about 30%;
(c) a crystalline, random terpolymer of propylene and two olefins selected from ethylene and C₄-C₈ α-olefins wherein the polymerized olefin content is about 1% to about 5% by weight, preferably about 1% to about 4%, when ethylene is used, and about 1% to about 20% by weight, preferably about 1% to about 16%, when the C₄-C₁₀ α-olefins are used, the terpolymer having solubility in xylene at room temperature lower than about 15%;
(d) an olefin polymer composition comprising:
   (i) about 10% to about 60% by weight, preferably about 15% to about 55%, of a crystalline propylene homopolymer having solubility in xylene at room temperature at most about 20%, preferably about 90 to about 99.5%, or a crystalline copolymer of monomers selected from (a) propylene and ethylene, (b) propylene, ethylene and a C₄-C₈ α-olefin, and (c) propylene and a C₄-C₈ α-olefin, the copolymer having a polymerized propylene content of more than about 85% by weight, preferably about 90% to about 99%, and solubility in xylene at room temperature lower than about 40%;
   (ii) about 3% to about 25% by weight, preferably about 5% to about 20%, of a copolymer of ethylene and propylene or a C₄-C₈ α-olefin that is insoluble in xylene at ambient temperature; and
   (iii) about 10% to about 80% by weight, preferably about 15% to about 65%, of an elastomeric copolymer of monomers selected from (a) ethylene and propylene, (b) ethylene, propylene, and a C₄-C₈ α-olefin, and (c) ethylene and a C₄-C₈ α-olefin, the copolymer optionally containing about 0.5% to about 10% by weight of a polymerized diene and containing less than about 70% by weight, preferably about 10% to about 60%, most preferably about 12% to about 55%, of polymerized ethylene, and being soluble in xylene at ambient temperature and having an intrinsic viscosity of about 1.5 to about 6.0 dl/g;
wherein the total of (ii) and (iii), based on the total olefin polymer composition is about 50% to about 90% by weight, and the weight ratio of (ii)/(iii) is less than about 0.4, preferably about 0.1 to about 0.3, and the composition is prepared by polymerization in at least two stages;
(e) a soft olefin polymer comprising:
   A) about 8 to about 40% by weight of a crystalline polymer fraction selected from:
      (i) a propylene homopolymer, having solubility in xylene at room temperature lower than about 10% by weight;
      (ii) a copolymer of propylene and at least one alpha-olefin of formula H₂C═CHR, where R is H or a C₂₋₁₀ linear or branched alkyl, containing at least about 85% by weight of propylene, having solubility in xylene at room temperature lower than about 15% by weight; and
      (iii) a mixture of (i) and (ii); and
   B) about 60 to about 92% by weight of an elastomeric fraction comprising at least an elastomeric copolymer of propylene or ethylene with about 15 to about 45% by weight of at least one alpha-olefin of formula H₂C═CHR, where R is H or a C₂₋₁₀ linear or branched alkyl, optionally containing about 0.5 to about 5% by weight of a diene, and having solubility in xylene at room temperature greater than about 50% by weight, the intrinsic viscosity of the xylene soluble fraction ranging from about 3.0 to about 6.5 dl/g;
(f) homopolymers of ethylene;
(g) random copolymers of ethylene and an α-olefin selected from C₃-C₁₀ α-olefins having a polymerized α-olefin content of about 1 to about 20% by weight, preferably about 2% to about 16%;
(h) random terpolymers of ethylene and two C₃-C₁₀ α-olefins having a polymerized α-olefin content of about 1% to about 20% by weight, preferably about 2% to about 16%;
(i) homopolymers of butene-1;
(j) copolymers or terpolymers of butene-1 with ethylene, propylene or C₅-C₁₀ α-olefin, the comonomer content ranging from about 1 mole % to about 15 mole %; and
(k) mixtures thereof.

Preferably, the olefin polymer is selected from:
(a) a crystalline homopolymer of propylene having solubility in xylene at room temperature lower than about 20%, preferably about 0.5% to about 10%;
(b) a crystalline, random copolymer of propylene with an olefin selected from ethylene and C₄-C₁₀ α-olefins wherein the polymerized olefin content is about 1-10% by weight, preferably about 2% to about 8%, when ethylene is used, and about 1% to about 20% by weight, preferably about 2% to about 16%, when the C₄-C₁₀ α-olefin is used, the copolymer having solubility in xylene at room temperature lower than about 40%, preferably at most about 30%; and
(c) a soft olefin polymer comprising:
   A) about 8 to about 40% by weight of a crystalline polymer fraction selected from:
      (i) a propylene homopolymer, having solubility in xylene at room temperature lower than about 10% by weight;
      (ii) a copolymer of propylene and at least one alpha-olefin of formula H₂C═CHR, where R is H or a C₂₋₁₀ linear or branched alkyl, containing at least about 85% by weight of propylene, having solubility in xylene at room temperature lower than about 15% by weight; and
      (iii) a mixture of (i) and (ii); and
   B) about 60 to about 92% by weight of an elastomeric fraction comprising at least an elastomeric copolymer of propylene or ethylene with about 15 to about 45% by weight of at least one alpha-olefin of formula H₂C═CHR, where R is H or a C₂₋₁₀ linear or branched alkyl, optionally containing about 0.5 to about 5% by weight of a diene, and having solubility in xylene at room temperature greater than about 50% by weight, the intrinsic viscosity of the xylene soluble fraction ranging from about 3.0 to about 6.5 dl/g;

Most preferably, the olefin polymer is a propylene homopolymer having solubility in xylene at room temperature lower than about 10%.

The useful polybutene-1 homo or copolymers can be isotactic or syndiotactic and have a melt flow rate (MFR) from about 0.1 to about 150 dg/min, preferably from about 0.3 to about 100, and most preferably from about 0.5 to about 75.

These butene-1 polymer materials, their methods of preparation and their properties are known in the art. Suitable polybutene-1 polymers can be obtained, for example, by using Ziegler-Natta catalysts to initiate butene-1 polymerization, as described in WO 99/45043, or by metallocene initiated polymerization of butene-1 as described in WO 02/102811, the disclosures of which are incorporated herein by reference.

Preferably, the butene-1 polymer materials contain up to about 15 mole % of copolymerized ethylene or propylene. More preferably, the butene-1 polymer material is a homopolymer having a crystallinity of at least about 30% by weight measured with wide-angle X-ray diffraction after 7 days, more preferably about 45% to about 70%, most preferably about 55% to about 60%.

The reactive, peroxide-containing olefin polymer has a peroxide concentration typically ranging from about 5 to about 200 milli-equivalent per kilogram of the polymer (meq/kg), and preferably ranging from about 10 to about 50.

The reactive, peroxide-containing olefin polymer may be prepared by using an irradiation and oxidation process by exposing the olefin polymer starting material to high energy ionizing radiation in an essentially oxygen-free environment, i.e., an environment in which the active oxygen concentration is established and maintained at 0.004% by volume or less. The olefin polymer starting material is exposed to high-energy ionizing radiation under a blanket of inert gas, preferably nitrogen. The ionizing radiation should have sufficient energy to penetrate the mass of polymer material being irradiated to the extent desired. The ionizing radiation can be of any kind, but preferably includes electrons and gamma rays. More preferred are electrons beamed from an electron generator having an accelerating potential of 500-4,000 kilovolts. Satisfactory results are obtained at a dose of ionizing radiation of about 0.1 to about 15 megarads (“Mrad”), preferably about 0.5 to about 9.0 Mrad.

The term “rad” is usually defined as that quantity of ionizing radiation that results in the absorption of 100 ergs of energy per gram of irradiated material regardless of the source of the radiation using the process described in U.S. Pat. No. 5,047,446. Energy absorption from ionizing radiation is measured by the well-known convention dosimeter, a measuring device in which a strip of polymer film containing a radiation-sensitive dye is the energy absorption sensing means. Therefore, as used in this specification, the term “rad” means that quantity of ionizing radiation resulting in the absorption of the equivalent of 100 ergs of energy per gram of the polymer film of a dosimeter placed at the surface of the olefin material being irradiated, whether in the form of a bed or layer of particles, or a film, or a sheet.

The irradiated olefin polymer material is then oxidized in a series of steps. According to a preferred preparation method, a first treatment step consists of heating the irradiated polymer, in the presence of a first controlled amount of active oxygen greater than 0.004% by volume but less than 21% by volume, preferably less than 15% by volume, more preferably less than 8% by volume, and most preferably from 0.5% to 5.0% by volume, to a first temperature of at least 25° C. but below the softening point of the polymer, preferably about 25° C. to 140° C., more preferably about 40° C. to 100° C., and most preferably about 50° C. to 90° C. Heating to the desired temperature is accomplished as quickly as possible, preferably in less than 10 minutes. The polymer is then held at the selected temperature, typically for about 5 to 90 minutes, to increase the extent of reaction of the oxygen with the free radicals in the polymer. The holding time, which can be determined by one skilled in the art, depends upon the properties of the starting material, the active oxygen concentration used, the irradiation dose, and the temperature. The maximum time is determined by the physical constraints of the fluid bed used to treat the polymer.

In a second treatment step, the irradiated polymer is heated, in the presence of a second controlled amount of oxygen greater than 0.004% by volume but less than 21% by volume, preferably less than 15% by volume, more preferably less than 8% by volume, and most preferably from 0.5% to 5.0% by volume, to a second temperature of at least 25° C. but below the softening point of the polymer. Preferably, the second temperature is from 80° C. to less than the softening point of the polymer, and the same as or greater than the temperature of the first treatment step. The polymer is then held at the selected temperature and oxygen concentration conditions for about 10 to 300 minutes, preferably about 20 to 180 minutes, most preferably about 30 to 60 minutes, to minimize the recombination of chain fragments, i.e., to minimize the formation of long chain branches. The holding time is determined by the same factors discussed in relation to the first treatment step.

In an optional third step, the oxidized olefin polymer material is heated under a blanket of inert gas, preferably nitrogen, to a third temperature of at least 80° C. but below the softening point of the polymer, and held at that temperature for about 10 to about 120 minutes, preferably about 60 minutes. A more stable product is produced if this step is carried out. It is preferred to use this step if the reactive, peroxide-containing olefin polymer material is going to be stored rather than used immediately, or if the radiation dose that is used is on the high end of the range described above. The polymer is then cooled to a fourth temperature of about below 50° C. under a blanket of inert gas, preferably nitrogen, before being discharged from the bed. In this manner, stable intermediates are formed that can be stored at room temperature for long periods of time without further degradation.

As used in this specification, the expression “room temperature” or “ambient” temperature means approximately 25° C. The expression “active oxygen” means oxygen in a form that will react with the irradiated olefin polymer material. It includes molecular oxygen, which is the form of oxygen normally found in air. The active oxygen content requirement of this invention can be achieved by replacing part or all of the air in the environment by an inert gas such as, for example, nitrogen.

It is preferred to carry out the treatment by passing the irradiated polymer through a fluid bed assembly operating at a first temperature in the presence of a first controlled amount oxygen, passing the polymer through a second fluid bed assembly operating at a second temperature in the presence of a second controlled amount of oxygen, and then maintaining the polymer at a third temperature under a blanket of nitrogen, in a third fluid bed assembly. In commercial operation, a continuous process using separate fluid beds for the first two steps, and a purged, mixed bed for the third step is preferred. However, the process can also be carried out in a batch mode in one fluid bed, using a fluidizing gas stream heated to the desired temperature for each treatment step. Unlike some techniques, such as melt extrusion methods, the fluidized bed method does not require the conversion of the irradiated polymer into the molten state and subsequent re-solidification and comminution into the desired form. The fluidizing medium can be, for example, nitrogen or any other gas that is inert with respect to the free radicals present, e.g., argon, krypton, and helium.

The concentration of peroxide groups formed on the polymer can be controlled easily by varying the radiation dose during the preparation of the reactive, peroxide-containing olefin polymer and the amount of oxygen to which such polymer is exposed after irradiation. The oxygen level in the fluid bed gas stream is controlled by the addition of dried, filtered air at the inlet to the fluid bed. Air must be constantly added to compensate for the oxygen consumed by the formation of peroxides in the polymer.

Alternatively, the reactive, peroxide-containing olefin polymer materials could be prepared according to the following procedures. In a first treatment step, the polymer starting material was treated with 0.1 to 10 wt % of an organic peroxide initiator while adding a controlled amount of oxygen so that the olefin polymer material is exposed to greater than 0.004% but less than 21% by volume, preferably less than 15%, more preferably less than 8% by volume, and most preferably 1.0% to 5.0% by volume, at a temperature of at least 25° C. but below the softening point of the polymer, preferably about 25° C. to about 140° C. In a second treatment step, the polymer is then heated to a temperature of at least 25° C. up to the softening point of the polymer, preferably from 100° C. to less than the softening point of the polymer, at an oxygen concentration that is within the same range as in the first treatment step. The total reaction time is typically about 0.5 hour to four hours. After the oxygen treatment, the polymer is optionally treated at a temperature of at least 80° C. but below the softening point of the polymer, typically for 0.5 hour to about two hours, in an inert atmosphere such as nitrogen to quench any active free radicals.

Suitable organic peroxides include acyl peroxides, such as benzoyl and dibenzoyl peroxides; dialkyl and aralkyl peroxides, such as di-tert-butyl peroxide, dicumyl peroxide; cumyl butyl peroxide; 1,1,-di-tert-butylperoxy-3,5,5-trimethylcyclohexane; 2,5-dimethyl-1,2,5-tri-tert-butylperoxyhexane, and bis(alpha-tert-butylperoxy isopropylbenzene), and peroxy esters such as bis(alpha-tert-butylperoxy pivalate; tert-butylperbenzoate; 2,5-dimethylhexyl-2,5-di(perbenzoate); tert-butyl-di(perphthalate); tert-butylperoxy-2-ethylhexanoate, and 1,1-dimethyl-3-hydroxybutylperoxy-2-ethyl hexanoate, and peroxycarbonates such as di(2-ethylhexyl) peroxy dicarbonate, di(n-propyl)peroxy dicarbonate, and di(4-tert-butylcyclohexyl)peroxy dicarbonate. The peroxides can be used neat or in diluent medium.

The peroxide concentration of the reactive, peroxide-containing olefin polymers can be optionally increased by an enrichment process. In a typical enrichment process, a peroxide-containing olefin polymer is contacted with a first gas mixture having a first oxygen concentration in a reactor. The oxygen concentration in the gas mixture is typically greater than 0.004% but less than 15% by volume, preferably less than 8%, more preferably from about 0.1 to about 6% by volume, and most preferably from about 0.2% to 4% by volume of oxygen, with respect to the total volume of the gas mixture, wherein the gas mixture typically contains oxygen in nitrogen, which is preferred for the gas mixture employed in the process of the present invention. The peroxide-containing olefin polymer is then heated to a first temperature at least equal to a preparative temperature, but below the softening point of the polymer, preferably about 100° C. to about 145° C. in the presence of a second gas mixture having a second oxygen concentration, from greater than 0.004% but less than 15% by volume, preferably less than 8%, more preferably from about 0.1 to about 6% by volume, and most preferably from about 0.2% to 4% by volume of oxygen, with respect to the total volume of the gas mixture, wherein the gas mixture typically contains oxygen in nitrogen, which is preferred for the gas mixture employed in the process of the present invention. The preparative temperature is a last heat treatment temperature used in the preparation of the peroxide-containing olefin polymer by either the irradiation process or liquid peroxide process described above. The total reaction time is typically up to three hours. After the oxygen treatment, the olefin polymer is treated at a second temperature of at least 80° C. but below the softening point of the polymer, typically for one hour, in an atmosphere having an oxygen concentration of at most 0.004% by volume to deactivate any active free radicals before it is cooled, discharged and collected, thereby forming a reactive, peroxide-containing olefin polymer with enriched peroxide concentration.

The reactive, peroxide-containing olefin polymers used in the process of the invention are easy to handle and may be stored for long periods of time without the need of specific storage requirement.

The polymer mixture comprises from about 0.1 to about 3.0% by weight of an organic peroxide, preferably about 0.2 to about 1.0%.

The organic peroxide includes acyl peroxides, such as benzoyl and dibenzoyl peroxides; dialkyl and aralkyl peroxides, such as di-tert-butyl peroxide, dicumyl peroxide; cumyl butyl peroxide; 1,1,-di-tert-butylperoxy-3,5,5-trimethylcyclohexane; 2,5-dimethyl-1,2,5-tri-tert-butylperoxyhexane, and bis(alpha-tert-butylperoxy isopropylbenzene), and peroxy esters such as bis(alpha-tert-butylperoxy pivalate; tert-butylperbenzoate; 2,5-dimethylhexyl-2,5-di(perbenzoate); tert-butyl-di(perphthalate); tert-butylperoxy-2-ethylhexanoate, and 1,1-dimethyl-3-hydroxybutylperoxy-2-ethyl hexanoate, and peroxycarbonates such as di(2-ethylhexyl) peroxy dicarbonate, di(n-propyl)peroxy dicarbonate, and di(4-tert-butylcyclohexyl)peroxy dicarbonate. The peroxides can be used neat or in diluent medium. In all the cases, whether or not a solvent or diluent is present, the amount of the organic peroxide given above is based on the actual organic peroxide content.

The polymer mixture optionally contains about 1% to about 10% by weight of a co-agent, preferably about 2% to about 8%, more preferably about 3% to about 5%. The co-agent is a chemical compound having a molecular structure containing at least two aliphatic unsaturated carbon-carbon bonds; preferably, the co-agent is selected from polybutadiene, polyisoprene, furan derivatives and mixtures thereof.

The polymer mixture of the present invention may also contain conventional additives, for instance, anti-acid stabilizers, such as, calcium stearate, hydrotalcite, zinc stearate, calcium oxide, and sodium stearate.

The polymer mixture can be extruded or compounded in molten state in any conventional manner well known in the art, in batch or continuous mode; for example, by using a Banbury mixer, a kneading machine, a single screw extruder, a twin screw extruder or an autoclave equipped with adequate agitation.

Unless otherwise specified, the properties of the olefin polymer materials, compositions and other characteristics that are set forth in the following examples have been determined according to the test methods reported below:
Melt Flow Rate (MFR): ASTM D1238, units of dg/min; 230° C., 2.16 kg; Polymer material with a MFR below 100, using full die; Polymer material with a MFR equal or above 100, using ½ die; unless otherwise specified.
Solubility in Xylene at Room Temperature (XSRT): Defined as the percent of olefin polymer soluble in xylene at room temperature. The weight percent of olefin polymer soluble in xylene at room temperature is determined by dissolving 2.5 g of polymer in 250 ml of xylene at room temperature in a vessel equipped with a stirrer, and heating at 135° C. with agitation for 20 minutes. The solution is cooled to 25° C. while continuing the agitation, and then left to stand without agitation for 30 minutes so that the solids can settle. The solids are filtered with filter paper, the remaining solution is evaporated by treating it with a nitrogen stream, and the solid residue is vacuum dried at 80° C. until a constant weight is reached.
Peroxide Concentration: Quantitative Organic Analysis via Functional Groups, by S. Siggia et al., 4th Ed., NY, Wiley 1979, pp. 334-42.
Tensile Properties: ASTM D-412 (crosshead speed is 508 mm/min.; extensometer gauge length is 12.7 mm; the specimen is ½ sized type C bar).
Tension Set: ASTM D-412 (specimen are 2 mm thick compression molded plaques according to ISO 2285).
Torque viscosity: The energy of mixing recorded as torque in meter-grams force (m-gmf) by the mixing unit, Haake Rheocord. The torque viscosity value was recorded when a constant viscosity reading was achieved.

In this specification, all parts, percentages and ratios are by weight, and all properties are measured at room temperature unless otherwise specified.

The reactive, peroxide-containing olefin polymer materials used in the experiments are prepared according to the following procedures.

Preparation 1

A reactive, peroxide-containing propylene polymer (P1) was prepared from a propylene homopolymer, having a melt flow rate (MFR) of 9.0 dg/min, XSRT of 3.5%, commercially available from Basell USA Inc. The homopolymer was irradiated at 4.0 Mrad under a blanket of nitrogen and then treated with 20.9% by volume of oxygen at room temperature for 60 minutes. The oxygen was then removed and the polymer was stored in a container filled with a blanket of nitrogen.

The polymer was transferred into a 3.8 liter autoclave and then heated to 140° C. under an oxygen-containing gas mixture. The total gas flow rate in the reactor was kept at 56.6 standard liter per hour (SLH) and the oxygen concentration was 2.0% by volume in nitrogen. The reactor was maintained at 140° C. for 60 minutes. The oxygen was then removed and the reactor was held at 140° C. under a blanket of nitrogen for another 60 minutes. Finally, the resultant propylene polymer was cooled, discharged and collected. The MFR of the reactive, peroxide-containing propylene polymer was 7778 dg/min. The peroxide concentration was 70.8 meq/kg of polymer.

Preparation 2

A reactive, peroxide-containing propylene polymer (P2) was prepared from a heterophasic propylene copolymer having a MFR of 0.10 dg/min. The copolymer was prepared in a three-stage sequential polymerization carried out in the presence of Ziegler-Natta catalysts as discussed above. The composition of the copolymer comprises (A) 33% by weight of a crystalline polymer fraction having XSRT of 5.5%, containing ethylene units of 3.8% and propylene units of 96.2%; (B) 41% by weight of a copolymer of propylene having XSRT of 92%, containing propylene units of 73% and ethylene units of 27%; and (C) 26% by weight of a copolymer of propylene having XSRT of 92%, containing propylene units of 73% and ethylene units of 27%. The copolymer was irradiated at 2.0 Mrad under a blanket of nitrogen. The irradiated copolymer was then treated with 20.9% by volume of oxygen at room temperature for 60 minutes. The oxygen was then removed and the polymer was stored in a container filled with a blanket of nitrogen. The MFR of the reactive, peroxide-containing propylene polymer was 5.95 dg/min. The peroxide concentration was 11.8 meq/kg of polymer.

### EXAMPLE 1

A thermoplastic olefin polymer material (E1), having a MFR of 0.07 dg/min and XSRT of 63.3%, was prepared in a three-stage sequential polymerization carried out in the presence of Ziegler-Natta catalysts as discussed above. The polymer material comprises (A) 19% by weight of a crystalline polymer fraction, having XSRT of 6.0%, containing ethylene units of 3.5% and propylene units of 96.5%; and (B) 81% by weight of an elastomeric fraction. The elastomeric fraction comprises a first elastomeric copolymer of ethylene with 25% of 1-butene, having XSRT of 47%, the weight of which is 25% of the polymer material, and a second elastomeric copolymer of propylene with 27% of ethylene, having XSRT of 92%, the weight of which is 56% of the polymer material. The thermoplastic olefin polymer material was mixed with a reactive, peroxide-containing propylene polymer (P1), an organic peroxide (PO), LuperoxF40MG (1,1′-bis(t-butylperoxy)diisopropylbenzene, 40% active), purchased from AtoFina, and a stabilization package.

The antioxidants, Irganox 1010, and Santonox TMBC (TMBC), 4,4′-thio-bis-(6-t-butyl-m-cresol) were obtained from Ciba Specialty Chemicals Corporation.

The materials were dry-blended, bag mixed and compounded in a Haake Rheocord internal mixer with a 60 gram size chamber and CAM type mixing blades, commercially available from Thermo Electron Corporation. The compounding temperature was 180° C. and the blade speed was 100 rpm. The melt was mixed in the chamber until a constant viscosity was observed. The polymer melt was then placed in a 11.4×11.4×2 mm picture frame mold and compression molded into plaques at 200° C. The mold was cooled to room temperature by transferring the hot mold to a compression molding unit set at 23° C. The mold was kept under 23° C. for about 5 minutes before removing the plaque from the mold.

### EXAMPLE 2

A thermoplastic olefin polymer material (E1) described in Example 1 was mixed with a reactive, peroxide-containing propylene polymer (P1), an organic peroxide (PO) and a stabilization package. The compounding and sample preparation procedure is the same as that in Example 1.

### COMPARATIVE EXAMPLE 1

A thermoplastic olefin polymer material (E1) described in Example 1 was mixed with a stabilization package. The compounding and sample preparation procedure is the same as that in Example 1.

### COMPARATIVE EXAMPLE 2

A thermoplastic olefin polymer material (E1) described in Example 1 was mixed with an organic peroxide (PO) and a stabilization package. The compounding and sample preparation procedure is the same as that in Example 1.

### COMPARATIVE EXAMPLE 3

A thermoplastic olefin polymer material (E1) described in Example 1 was mixed with a reactive, peroxide-containing olefin polymer (P1) and a stabilization package. The compounding and sample preparation procedure is the same as that in Example 1.

The composition of Examples 1-2 and Comparative Examples 1-3 is summarized in Table 1.

TABLE 1

| | | Composition (parts by weight) | | | |
|---|---|---|---|---|---|
| | Type of | Amount of | | | Irganox |
| Examples | polyolefins | polyolefins | P1 | PO | 1010 |
| Example 1 | E1 | 100 | 10 | 0.25 | 0.1 |
| Example 2 | E1 | 100 | 10 | 0.50 | 0.1 |
| Comparative Ex. 1 | E1 | 100 | 0 | 0 | 0.1 |
| Comparative Ex. 2 | E1 | 100 | 0 | 0.50 | 0.1 |
| Comparative Ex. 3 | E1 | 100 | 10 | 0 | 0.1 |

Physical properties and melt behavior of Examples 1-2 and Comparative Examples 1-3 are summarized in Table 2. Lower tension set value indicates better elastic recovery and lower torque viscosity reflects better processibility of the thermoplastic elastomer in melton state. The Examples containing both an organic peroxide (PO) and a reactive, peroxide-containing propylene polymer (P1) show a better balance of the elasticity and the torque viscosity as compared with those of the Comparative Examples. The low torque viscosity, which equates to low melt viscosity makes the compositions represented by Examples 1-2 easier to be mixed or compounded.

TABLE 2

| | | 100% | Tensile | 100% | Torque |
|---|---|---|---|---|---|
| | Elongation | Modulus | Strength | Tension | viscosity |
| Properties | (%) | (MPa) | (MPa) | set (%) | (m-gmf) |
| Example 1 | 838 | 4.40 | 10.3 | 35.0 | 1030 |
| Example 2 | 741 | 4.86 | 7.49 | 30.0 | 800 |
| Comparative | 774 | 3.61 | 13.4 | 40.0 | 1400 |
| Ex. 1 | | | | | |
| Comparative | 277 | 4.92 | 5.85 | 29.0 | 1500 |
| Ex. 2 | | | | | |
| Comparative | 757 | 4.94 | 11.1 | 35.0 | 1270 |
| Ex. 3 | | | | | |

### EXAMPLE 3

A thermoplastic olefin polymer material (E1) described in Example 1 was mixed with a reactive, peroxide-containing propylene polymer (P2), an organic peroxide (PO) and a stabilization package. The compounding and sample preparation procedure is the same as that in Example 1.

### EXAMPLE 4

A thermoplastic olefin polymer material (E1) described in Example 1 was mixed with a reactive, peroxide-containing propylene polymer (P2), an organic peroxide (PO) and a stabilization package. The compounding and sample preparation procedure is the same as that in Example 1.

### COMPARATIVE EXAMPLE 4

A thermoplastic olefin polymer material (E1) described in Example 1 was mixed with a reactive, peroxide-containing propylene polymer (P2) and a stabilization package. The compounding and sample preparation procedure is the same as that in Example 1.

The composition of Examples 3-4 and Comparative Examples 1, 4 is summarized in Table 3.

TABLE 3

| | | Composition (parts by weight) | | | |
|---|---|---|---|---|---|
| | Type of | Amount of | | | Irganox |
| Examples | polyolefins | polyolefins | P2 | PO | 1010 |
| Example 3 | E1 | 100 | 10 | 0.25 | 0.1 |
| Example 4 | E1 | 100 | 10 | 0.50 | 0.1 |
| Comparative Ex. 1 | E1 | 100 | 0 | 0 | 0.1 |
| Comparative Ex. 4 | E1 | 100 | 10 | 0 | 0.1 |

Physical properties and melt behavior of Examples 3-4 and Comparative Examples 1, 4 are summarized in Table 4. The better balance of the physical properties and the melt viscosity of the Examples containing both PO and P2 indicates that the thermoplastic polyolefin elastomers so prepared have balanced elastomeric and processing properties as compared with those of the Comparative Examples.

TABLE 4

| | | 100% | Tensile | 100% | Torque |
|---|---|---|---|---|---|
| | Elongation | Modulus | Strength | Tension | viscosity |
| Properties | (%) | (MPa) | (MPa) | set (%) | (m-gmf) |
| Example 3 | 789 | 3.79 | 13.3 | 32.4 | 975 |
| Example 4 | 770 | 3.83 | 6.45 | 32.4 | 880 |
| Comparative | 774 | 3.61 | 13.4 | 40.0 | 1400 |
| Ex. 1 | | | | | |
| Comparative | 749 | 3.49 | 11.3 | 25.0 | 1750 |
| Ex. 4 | | | | | |

### EXAMPLE 5

A thermoplastic olefin polymer material (E2), having a MFR of 0.05 dg/min and XSRT of 76.7%, was prepared in a three-stage sequential polymerization carried out in the presence of Ziegler-Natta catalysts as discussed above. The polymer material comprises (A) 15% by weight of a crystalline polymer fraction, having XSRT of 6.0%, containing ethylene unit of 3.3% and propylene unit of 96.7%; and (B) 85% by weight of an elastomeric fraction. The elastomeric fraction comprises a first elastomeric copolymer of propylene with 38% of ethylene, having XSRT of 90%, the weight of which is 31% of the polymer material, and a second elastomeric copolymer of propylene with 28% of ethylene, having XSRT of 92%, the weight of which is 54% of the polymer material. The thermoplastic olefin polymer material was mixed with a reactive, peroxide-containing propylene polymer (P1), an organic peroxide (PO) and a stabilization package. The compounding and sample preparation procedure is the same as that in Example 1.

### EXAMPLE 6

A thermoplastic olefin polymer material (E2) described in Example 5 was mixed with a reactive, peroxide-containing propylene polymer (P1), an organic peroxide (PO) and a stabilization package. The compounding and sample preparation procedure is the same as that in Example 1.

### COMPARATIVE EXAMPLE 5

A thermoplastic olefin polymer material (E2) described in Example 5 was mixed with a stabilization package. The compounding and sample preparation procedure is the same as that in Example 1.

### COMPARATIVE EXAMPLE 6

A thermoplastic olefin polymer material (E2) described in Example 5 was mixed with a reactive, peroxide-containing propylene polymer (P1) and a stabilization package. The compounding and sample preparation procedure is the same as that in Example 1.

The composition of Examples 5-6 and Comparative Examples 5-6 is summarized in Table 5.

TABLE 5

| | | Composition (parts by weight) | | | |
|---|---|---|---|---|---|
| | Type of | Amount of | | | Irganox |
| Examples | polyolefins | polyolefins | P1 | PO | 1010 |
| Example 5 | E2 | 100 | 10 | 0.25 | 0.1 |
| Example 6 | E2 | 100 | 10 | 0.50 | 0.1 |
| Comparative Ex. 5 | E2 | 100 | 0 | 0 | 0.1 |
| Comparative Ex. 6 | E2 | 100 | 10 | 0 | 0.1 |

Physical properties and melt behavior of Examples 5-6 and Comparative Examples 5-6 are summarized in Table 6. The Examples containing both PO and P1 achieved both better elastomeric properties and lower torque viscosity as compared with those of the Comparative Examples.

TABLE 5

| | | 100% | Tensile | 100% | Torque |
|---|---|---|---|---|---|
| | Elongation | Modulus | Strength | Tension | viscosity |
| Properties | (%) | (MPa) | (MPa) | set (%) | (m-gmf) |
| Example 5 | 900 | 3.99 | 11.0 | 29.8 | 1040 |
| Example 6 | 830 | 3.70 | 10.0 | 30.0 | 1100 |
| Comparative | 766 | 3.72 | 12.6 | 36.0 | 1890 |
| Ex. 5 | | | | | |
| Comparative | 864 | 3.34 | 13.6 | 33.0 | 1270 |
| Ex. 6 | | | | | |

### EXAMPLE 7

A thermoplastic olefin polymer material (E2) described in Example 5 was mixed with a reactive, peroxide-containing propylene polymer (P2), an organic peroxide (PO) and a stabilization package. The compounding and sample preparation procedure is the same as that in Example 1.

### EXAMPLE 8

A thermoplastic olefin polymer material (E2) described in Example 5 was mixed with a reactive, peroxide-containing propylene polymer (P2), an organic peroxide (PO) and a stabilization package. The compounding and sample preparation procedure is the same as that in Example 1.

### COMPARATIVE EXAMPLE 7

A thermoplastic olefin polymer material (E2) described in Example 5 was mixed with a reactive, peroxide-containing propylene polymer (P2) and a stabilization package. The compounding and sample preparation procedure is the same as that in Example 1.

The composition of Examples 7-8 and Comparative Examples 5, 7 is summarized in Table 7.

TABLE 7

| | | Composition (parts by weight) | | | |
|---|---|---|---|---|---|
| | Type of | Amount of | | | Irganox |
| Examples | polyolefins | polyolefins | P2 | PO | 1010 |
| Example 7 | E2 | 100 | 10 | 0.25 | 0.1 |
| Example 8 | E2 | 100 | 10 | 0.50 | 0.1 |
| Comparative Ex. 5 | E2 | 100 | 0 | 0 | 0.1 |
| Comparative Ex. 7 | E2 | 100 | 10 | 0 | 0.1 |

Physical properties and melt behavior of Examples 7-8 and Comparative Examples 5, 7 are summarized in Table 8. The Examples containing both PO and P2 also show a better tension set and a low torque viscosity as compared with those of the Comparative Examples.

TABLE 5

| | | 100% | Tensile | 100% | Torque |
|---|---|---|---|---|---|
| | Elongation | Modulus | Strength | Tension | viscosity |
| Properties | (%) | (MPa) | (MPa) | set (%) | (m-gmf) |
| Example 7 | 850 | 2.78 | 8.48 | 28.0 | 1020 |
| Example 8 | 887 | 3.17 | 7.31 | 29.6 | 950 |
| Comparative | 766 | 3.72 | 12.6 | 36.0 | 1890 |
| Ex. 5 | | | | | |
| Comparative | 750 | 3.11 | 11.5 | 33.0 | 1800 |
| Ex. 7 | | | | | |

Other features, advantages and embodiments of the invention disclosed herein will be readily apparent to those exercising ordinary skill after reading the foregoing disclosures. In this regard, while specific embodiments of the invention have been described in considerable detail, variations and modifications of these embodiments can be effected without departing from the spirit and scope of the invention as described and claimed.

What is claimed is:

1. A process for making a thermoplastic polyolefin elastomer comprising:
a) preparing a polymer mixture comprising:
(I) about 70 to about 95% by weight of a heterophasic polyolefin composition comprising the following fractions:
A) about 8 to about 40% by weight of a crystalline polymer fraction selected from:
(i) a propylene homopolymer, having solubility in xylene at room temperature lower than about 10% by weight;
(ii) a copolymer of propylene and at least one alpha-olefin of formula H₂C═CHR, where R is H or a C₂₋₁₀ linear or branched alkyl, containing at least about 85% by weight of propylene, having solubility in xylene at room temperature lower than about 15% by weight; and
(iii) a mixture of (i) and (ii); and
B) about 60 to about 92% by weight of an elastomeric fraction comprising at least an elastomeric copolymer of propylene or ethylene with about 15 to about 45% by weight of at least one alpha-olefin of formula H₂C═CHR, where R is H or a C₂₋₁₀ linear or branched alkyl, optionally containing about 0.5 to about 5% by weight of a diene, and having solubility in xylene at room temperature greater than about 50% by weight;
(II) about 4.9 to about 27% by weight of a reactive, peroxide-containing olefin polymer;
(III) about 0.1 to about 3.0% by weight of an organic peroxide; and
(IV) optionally, about 1 to about 10% by weight of a co-agent having a molecular structure containing at least two aliphatic unsaturated carbon-carbon bonds; wherein (I)+(II)+(III)+(IV) equals 100%;
b) extruding or compounding in molten state the polymer mixture, thereby producing a melt mixture; and optionally
c) pelletizing the melt mixture.

2. The process according to claim 1 wherein the reactive, peroxide-containing olefin polymer material is prepared from an olefin polymer starting material selected from a propylene polymer material, an ethylene polymer material and a butene-1 polymer material.

3. The process according to claim 2 wherein the propylene polymer material is selected from:
(a) a crystalline homopolymer of propylene having solubility in xylene at room temperature lower than about 20%;
(b) a crystalline, random copolymer of propylene with an olefin selected from ethylene and C₄-C₁₀ α-olefins wherein the polymerized olefin content is about 1-10% by weight when ethylene is used, and about 1% to about 20% by weight when the C₄-C₁₀ α-olefin is used, the copolymer having solubility in xylene at room temperature lower than about 40%;
(c) a crystalline, random terpolymer of propylene and two olefins selected from ethylene and C₄-C₈ α-olefins wherein the polymerized olefin content is about 1% to about 5% by weight when ethylene is used, and about 1% to about 20% by weight when the C₄-C₁₀ α-olefins are used, the terpolymer having solubility in xylene at room temperature lower than about 15%;
(d) an olefin polymer composition comprising:
(i) about 10% to about 60% by weight of a crystalline propylene homopolymer having solubility in xylene at room temperature lower than about 20% or a crystalline copolymer of monomers selected from (a) propylene and ethylene, (b) propylene, ethylene and a C₄-C₈ α-olefin, and (c) propylene and a C₄-C₈ α-olefin, the copolymer having a polymerized propylene content of more than about 85% by weight, and solubility in xylene at room temperature lower than about 40%;
(ii) about 3% to about 25% by weight of a copolymer of ethylene and propylene or a C₄-C₈ α-olefin that is insoluble in xylene at ambient temperature; and
(iii) about 10% to about 85% by weight of an elastomeric copolymer of monomers selected from (a) ethylene and propylene, (b) ethylene, propylene, and a C₄-C₈ α-olefin, and (c) ethylene and a C₄-C₈ α-olefin, the copolymer optionally containing about 0.5% to about 10% by weight of a polymerized diene and containing less than about 70% by weight of polymerized ethylene, and being soluble in xylene at ambient temperature and having an intrinsic viscosity of about 1.5 to about 6.0 dl/g;
wherein the total of (ii) and (iii), based on the total olefin polymer composition is about 50% to about 90% by weight, and the weight ratio of (ii)/(iii) is less than about 0.4, and the composition is prepared by polymerization in at least two stages;
(e) a soft olefin polymer comprising:
A) from about 8 to about 40% by weight of a crystalline polymer fraction selected from:
(i) a propylene homopolymer, having solubility in xylene at room temperature lower than about 10% by weight;
(ii) a copolymer of propylene and at least one alpha-olefin of formula H₂C═CHR, where R is H or a C₂₋₁₀ linear or branched alkyl, containing at least about 85% by weight of propylene, having solubility in xylene at room temperature lower than about 15% by weight; and
(iii) a mixture of (i) and (ii); and
B) from about 60 to about 92% by weight of an elastomeric fraction comprising at least an elastomeric copolymer of propylene or ethylene with about 15 to about 45% by weight of at least one alpha-olefin of formula H₂C═CHR, where R is H or a C₂₋₁₀ linear or branched alkyl, optionally containing about 0.5 to about 5% by weight of a diene, and having solubility in xylene at room temperature greater than about 50% by weight; and
(f) mixtures thereof.

4. The process according to claim 3 wherein the propylene polymer material is a crystalline homopolymer of propylene having solubility in xylene at room temperature lower than about 20%.

5. The process according to claim 2 wherein the ethylene polymer material is selected from:
(a) homopolymers of ethylene;
(b) random copolymers of ethylene and an α-olefin selected from C₃-C₁₀ α-olefins having a polymerized α-olefin content of about 1% to about 20% by weight;
(c) random terpolymers of ethylene and two C₃-C₁₀ α-olefins having a polymerized α-olefin content of about 1% to about 20% by weight; and
(d) mixtures thereof.

6. The process according to claim 2 wherein the butene-1 polymer material is selected from:
(a) homopolymers of butene-1;
(b) copolymers or terpolymers of butene-1 with ethylene, propylene or C₅-C₁₀ α-olefin, the comonomer content from about 1 mole % to about 15 mole %; and
(c) mixtures thereof.

7. A thermoplastic polyolefin elastomer made by a process comprising:
a) preparing a polymer mixture comprising:
(I) about 70 to about 95% by weight of a heterophasic polyolefin composition comprising the following fractions:
A) about 8 to about 40% by weight of a crystalline polymer fraction selected from:
(i) a propylene homopolymer, having solubility in xylene at room temperature lower than about 10% by weight;
(ii) a copolymer of propylene and at least one alpha-olefin of formula H₂C═CHR, where R is H or a C₂₋₁₀ linear or branched alkyl, containing at least about 85% by weight of propylene, having solubility in xylene at room temperature lower than about 15% by weight; and
(iii) a mixture of (i) and (ii); and
B) about 60 to about 92% by weight of an elastomeric fraction comprising at least an elastomeric copolymer of propylene or ethylene with about 15 to about 45% by weight of at least one alpha-olefin of formula H₂C═CHR, where R is H or a C₂₋₁₀ linear or branched alkyl, optionally containing about 0.5 to about 5% by weight of a diene, and having solubility in xylene at room temperature greater than about 50% by weight;
(II) about 4.9 to about 27% by weight of a reactive, peroxide-containing olefin polymer;
(III) about 0.1 to about 3.0% by weight of an organic peroxide; and
(IV) optionally, about 1 to about 10% by weight of a co-agent having a molecular structure containing at least two aliphatic unsaturated carbon-carbon bonds; wherein (I)+(II)+(III)+(IV) equals 100%;
b) extruding or compounding in molten state the polymer mixture, thereby producing a melt mixture; and optionally
c) pelletizing the melt mixture.
